(19) United States
(12) Patent Application Publication
(10) Pub. No.: US 2007/0014331 A1
(43) Pub. Date: Jan. 18, 2007

(54) Ultra-wideband communications system and method

(76) Inventors: John Eldon, Encinitas, CA (US); Adrian Macias, Vista, CA (US); Steve Moore, Escondido, CA (US)

Correspondence Address: PULSE-LINK, INC., 1969 KELLOGG AVENUE, CARLSBAD, CA, 92008, US

(21) Appl. No.: 11/179,951

(22) Filed: Jul. 12, 2005

(51) Int. Cl. H04B 1/69

(52) U.S. Cl. 375/130

(57) ABSTRACT

An ultra-wideband communications network and methods for communication are provided. In one embodiment of the present invention, a method of encoding data is provided. Generally, the method comprises the steps of calculating a data transformation, encoding a first portion of the data transform with a first forward error correction code at a first encoding rate, and encoding a second portion of the data transform with a second forward error correction code at a second encoding rate. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to ultra-wideband communications. More particularly, the invention concerns digital video data transmission over ultra-wideband communications channels.

### BACKGROUND OF THE INVENTION

The Information Age is upon us. Access to vast quantities of information through a variety of different communication systems are changing the way people work, entertain themselves, and communicate with each other.

For example, due to the 1996 Telecommunications Reform Act, traditional cable television program providers have now evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as in-home movies-on-demand and video teleconferencing demand high data transmission rates. Another example is interactive video in homes and offices.

Other industries are also placing bandwidth demands on Internet service providers, and other data providers. For example, hospitals transmit images of X-rays and CAT scans to remotely located physicians. Such transmissions require significant bandwidth to transmit the large data files in a reasonable amount of time. These large data files, as well as the large data files that provide real-time home video are simply too large to be feasibly transmitted without an increase in system bandwidth. The need for more bandwidth is evidenced by user complaints of slow Internet access and dropped data links that are symptomatic of network overload.

In addition, the wireless device industry has recently seen unprecedented growth. With the growth of this industry, communication between different wireless devices has become increasingly important. Conventional radio frequency (RF) technology has been the predominant technology for wireless communication for decades.

Conventional RF technology employs continuous carrier sine waves that are transmitted with data embedded thereon by modulation of the sine waves' amplitude or frequency. For example, a conventional cellular phone must operate at a particular frequency band of a particular width in the total frequency spectrum. Specifically, in the United States, the Federal Communications Commission (FCC) has allocated cellular phone communications in the 800 to 900 MHz band. Generally, cellular phone operators divide the allocated band into 25 MHz portions, with selected portions transmitting cellular phone signals, and other portions receiving cellular phone signals.

Another type of communication technology is ultra-wideband (UWB). One type of UWB technology employs discrete pulses of electromagnetic energy, and this type is fundamentally different from conventional carrier wave RF technology. UWB can employ a “carrier free” architecture, which does not require the use of high frequency carrier generation hardware, carrier modulation hardware, frequency and phase discrimination hardware or other devices employed in conventional frequency domain communication systems.

One feature of this type of UWB is that a UWB signal, or pulse, may occupy a very large amount of RF spectrum, for example, generally in the order of gigahertz of frequency band. Currently, the FCC has allocated the RF spectrum located between 3.1 gigahertz and 10.6 gigahertz for UWB communications. The FCC has also mandated that UWB signals, or pulses must occupy a minimum of 500 megahertz of RF spectrum.

Developers of UWB communication devices have proposed different architectures, or communication methods for ultra-wideband devices. In one approach, the available RF spectrum is partitioned into several discrete radio frequency bands, or portions. A UWB device may then transmit signals within one or more of these discrete frequency bands. Alternatively, a UWB communication device may occupy all, or substantially all, of the RF spectrum allocated for UWB communications.

However, both UWB communication technology, and conventional carrier wave technology are continually challenged by the bandwidth needs demanded by today's consumer.

Therefore, there remains a need to overcome one or more of the limitations in the above-described, existing art.

### BRIEF DESCRIPTION OF THE DRAWINGS

Various embodiments of the present invention taught herein are illustrated by way of example, and not by way of limitation, in the figures of the accompanying drawings in which like reference numerals are used to describe the same, similar or corresponding parts in the several views of the drawings:

FIG. 1 is an illustration of different communication methods;

FIG. 2 is an illustration of two ultra-wideband pulses;

FIG. 3 depicts the current United States regulatory mask for outdoor ultra-wideband communication devices;

FIG. 4 is an illustration of a network consistent with one embodiment of the present invention;

FIG. 5 is a depiction of a lossless compression technique employed by one embodiment of the present invention;

FIG. 6A is a depiction of another lossless compression technique employed by one embodiment of the present invention;

FIG. 6B is a depiction from a signal perspective of the lossless compression technique depicted in FIG. 6A;

FIG. 7 illustrates a filter-bank consistent with a 2-dimensional discrete wavelet transform;

FIG. 8 illustrates a decision tree used to encode data according to one embodiment of the present invention;

FIG. 9 illustrates one type of lossless compression method;

FIG. 10 illustrates one method of transmitting data;

FIG. 11 illustrates a second method of transmitting data; and

FIG. 12 illustrates a third method of transmitting data

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Unless defined otherwise, all technical and scientific terms used herein have the same meaning as is commonly understood by one of skill in the art to which this invention belongs. In event the definition in this section is not consistent with definitions elsewhere, the definitions set forth in this section will control.

The present invention provides a communication apparatus and method for ultra-wideband communications. The apparatus and method may employ a number of lossy and lossless compression formats to improve bandwidth, Quality-of-Service (QoS) or throughput of digital video data.

In one embodiment of the present invention, a method of encoding data is provided. Generally, the method comprises the steps of calculating a data transformation, encoding a first portion of the data transform with a forward error correction code at a first encoding rate, and encoding a second portion of the data transform with a forward error correction code at a second encoding rate. By using different encoding rates for different portions of data, the probability of receiving data of more interest is greatly improved. For example, a video image may be transformed using either a lossy or lossless compression technique. The transformed video image, now comprising data of higher and low value, may then be encoded at different encoding rates. The higher value data may receive an encoding rate that increases the probability of reception at a receiver.

One feature of the present invention is that it provides for network communications using ultra-wideband transceivers and lossy or lossless compression techniques. The transceivers may be in communication with physical storage media where files may be stored using a lossy or lossless compression format. The very high data transmission rate of some types of ultra-wideband (potentially, Gigabits/second, wirelessly) enables the wireless transmission of lossy or losslessly compressed High Definition (HD) communication signals, such as HDTV, or HD movies, or other types of HD video or images. Un-compressed HD video data transmission rates are about 1.5 Gigabits/second. One type of lossless compression can reduce the data rate by ⅔, thus reducing an HD signal to 500 Megabits/second. Still, no conventional carrier-wave wireless communication technology exists that can transmit at a 500 Megabit/second data rate. One feature of the present invention is the use of ultra-wideband technology to wirelessly transmit lossy or losslessly compressed HD signals, a feat unachievable with conventional communication technologies.

Another feature of the present invention provides network communications using ultra-wideband transceivers and lossy compression that uses wavelet-based compression methods.

The present invention may be practiced in wire or wireless networks or in a network employing both wireless and wire media. The ultra-wideband signal may be transmitted and received through the air or through any wire or guided medium. Without loss of generality the medium may be a twisted pair wire, a coaxial cable, a fiber optic cable, a power line media or other types of guided or wire media.

One embodiment of the present invention provides methods of increasing the information throughput of an ultra-wideband communications network. The information, generally in digital form, may be represented by a number of bits, or a bit stream. Using lossy or lossless compression techniques the size of the bit-stream required to convey the information is reduced, while all of the information is communicated across the medium.

One feature of the present invention is that it provides a communications network that can increase the available bandwidth, or data rates, of existing networks by enabling the simultaneous transmission of ultra-wideband communications signals on the same medium as conventional communications signals.

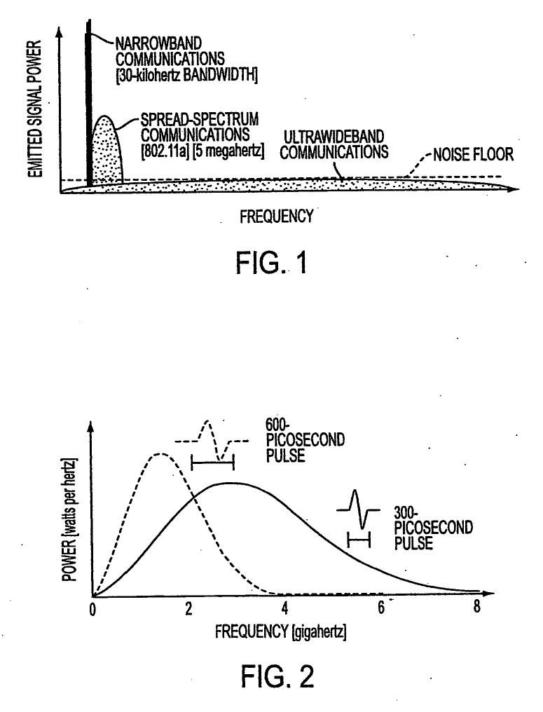

The embodiments of the present invention discussed below employ ultra-wideband communication technology. Referring to FIGS. 1 and 2, impulse type ultra-wideband (UWB) communication employs discrete pulses of electromagnetic energy that are emitted at, for example, nanosecond or picosecond intervals (generally tens of picoseconds to a few hundred nanoseconds in duration). For this reason, this type of ultra-wideband is often called “impulse radio.” That is, impulse type UWB pulses may be transmitted without modulation onto a sine wave, or a sinusoidal carrier, in contrast with conventional carrier wave communication technology. This type of UWB generally requires neither an assigned frequency nor a power amplifier.

An example of a conventional carrier wave communication technology is illustrated in FIG. 1. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave having a frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have about a 2.0 GHz center frequency, with a frequency spread of approximately 4 GHz, as shown in FIG. 2, which illustrates two typical impulse UWB pulses. FIG. 2 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.3 GHz. Thus, UWB pulses generally do not operate within a specific frequency, as shown in FIG. 1. Either of the pulses shown in FIG. 2 may be frequency shifted, for example, by using heterodyning, to have essentially the same bandwidth but centered at any desired frequency. And because UWB pulses are spread across an extremely wide frequency range, UWB communication systems allow communications at very high data rates, such as 100 megabits per second or greater.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may revise its current limits and allow for expanded use of UWB communication technology.

The FCC April 22 Report and Order requires that UWB pulses, or signals occupy greater than 20% fractional bandwidth or 500 megahertz, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and fₜ is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, f_{c}=(fₕ+fₜ)/2

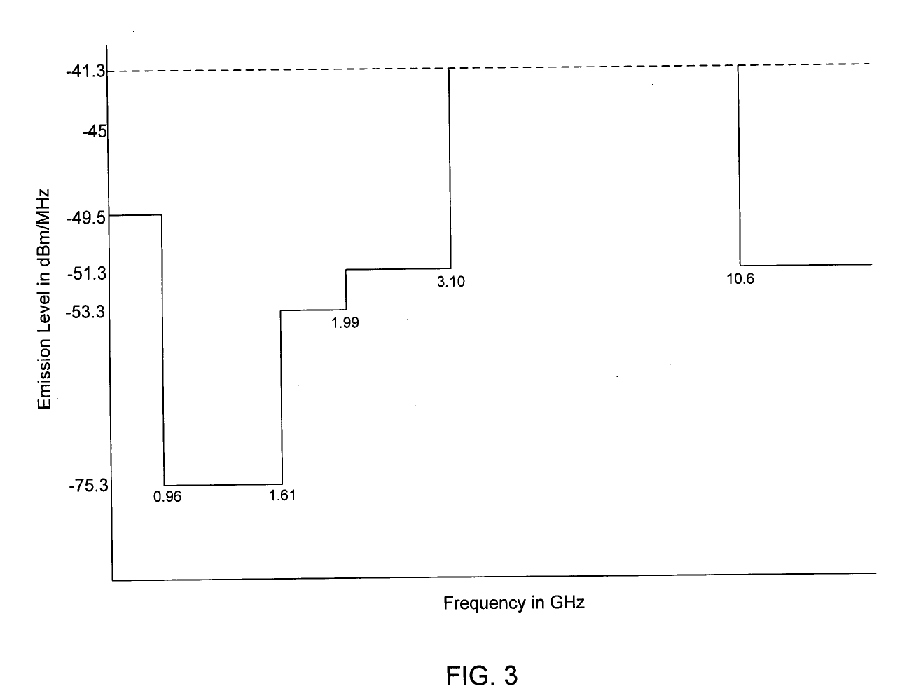

FIG. 3 illustrates the ultra-wideband emission limits for indoor systems mandated by the April 22 Report and Order. The Report and Order constrains UWB communications to the frequency spectrum between 3.1 GHz and 10.6 GHz, with intentional emissions to not exceed −41.3 dBm/MHz. The report and order also established emission limits for hand held UWB systems, vehicular radar systems, medical imaging systems, surveillance systems, through-wall imaging systems, ground penetrating radar and other UWB systems. It will be appreciated that the invention described herein may be employed indoors, and/or outdoors, and may be fixed, and/or mobile, and may employ either a wireless or wire media for a communication channel.

Generally, in the case of wireless communications, a multiplicity of UWB signals may be transmitted at relatively low power density (nano or micro watts per megahertz). However, an alternative UWB communication system, located outside the United States, may transmit at a higher power density. For example, UWB pulses may be transmitted between 30 dBm to −50 dBm.

UWB signals, however, transmitted through many wire media will not interfere with wireless radio frequency transmissions. Therefore, the power (sampled at a single frequency) of UWB signals transmitted though wire media may range from about +30 dBm to about −140 dBm. The FCC's April 22 Report and Order does not apply to communications through wire media.

Communication standards committees associated with the International Institute of Electrical and Electronics Engineers (IEEE) are considering a number of ultra-wideband (UWB) wireless communication methods that meet the constraints established by the FCC. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has approximately 242-nanosecond duration. It meets the FCC rules for UWB communications because it is an aggregation of many relatively narrow band carriers rather than because of the duration of each pulse.

Another UWB communication method being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being evaluated by the IEEE standards committees comprises transmitting a sequence of pulses that may be approximately 0.7 nanoseconds or less in duration, and at a chipping rate of approximately 1.4 giga pulses per second. The pulses are modulated using a Direct-Sequence modulation technique, and is known in the industry as DS-UWB. Operation in two or more bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated.

Another method of UWB communications comprises transmitting a modulated continuous carrier wave where the frequency occupied by the transmitted signal occupies more than the required 20 percent fractional bandwidth. In this method the continuous carrier wave may be modulated in a time period that creates the frequency band occupancy. For example, if a 4 GHz carrier is modulated using binary phase shift keying (BPSK) with data time periods of 750 picoseconds, the resultant signal may occupy 1.3 GHz of bandwidth around a center frequency of 4 GHz. In this example, the fractional bandwidth is approximately 32.5%. This signal would be considered UWB under the FCC regulation discussed above.

Thus, described above are four different methods of ultra-wideband (UWB) communication. It will be appreciated that the present invention may be employed by any of the above-described UWB methods, or others yet to be developed.

Also, because the UWB signal is spread across an extremely wide frequency range, the power sampled at a single, or specific frequency is very low. For example, the Power Spectral Density (PSD) of a UWB signal is well within the noise floor of conventional carrier wave signals and therefore does not interfere with the demodulation and recovery of the conventional carrier wave communication signals present on the media.

According to one embodiment of the invention, a transmitter may be configured to transmit both carrier-wave signals and UWB signals. The carrier-wave signals, for example, such as signals consistent with IEEE 802.11 standards or alternatively Bluetooth standards, and the UWB signals may be transmitted substantially simultaneously. The transmitter may include a carrier-wave transmitter portion that enables carrier-wave signals to be transmitted. A single antenna, or alternately multiple antennas, may be used for transmitting both the carrier-wave signals and the UWB signals.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention.

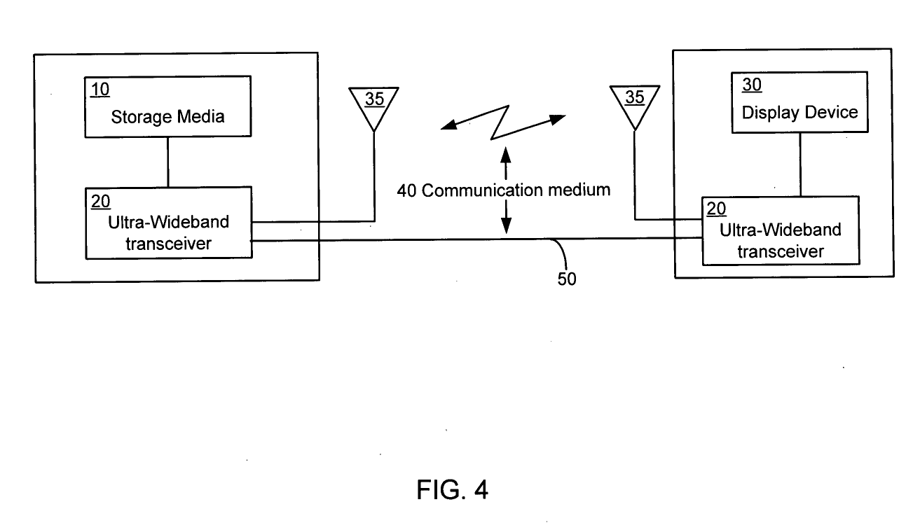

FIG. 4 illustrates two communications devices in a communications network. One device may contain storage media 10 and an ultra-wideband transceiver 20. Storage media 10 may include magnetic media, optical media, and solid-state media. In one embodiment of the present invention the storage media may contain data that is compressed in a lossy or lossless format. This lossy or lossless format may include a format based on wavelet transforms, such as the format descried in the JPEG 2000 specification. The specific details of the JPEG 2000 specification are known in the art and are not included in this discussion. For purposes of clarification and not limitation the following discussion of wavelet transforms is included.

A fundamental concept in data representation is that a bit-stream may be used to represent information. This bit-stream when viewed as a sequence of symbols is usually represented in time. An alternate method of viewing the symbols is in the frequency domain. The frequency domain does not represent symbols as a time based sequence but concerns itself with the transitions that occur from symbol to symbol. These transitions give rise to the notion of frequency, or how much, and what magnitude of change occurred within a sequence of symbols. Conventionally, a Fourier transformation is used to map the sequence in time domain into a data set in the frequency domain.

One difficulty encountered in the Fourier transform is the loss of information about time. This is due in part to the basis functions used to calculate the transform. In Fourier analysis the basis functions are Sin and Cosine. These functions exist from negative infinity to positive infinity. The Fourier Transform may be represented as:

$$F ( jw ) = {\int }_{- ∞}^{∞} f ( t ) {ⅇ}^{- j wt} ⅆ t$$

The Fourier transform is part of a class of transforms known as invertible transforms. The inverse transform may be represented as:

$$f ( t ) = \frac{1}{2 π} {\int }_{- ∞}^{∞} F ( jw ) {ⅇ}^{j wt} ⅆ w$$

where e^{jwt}=cos(wt)+j sin(wt)

The uses of Fourier transforms in signal processing are many. It is important to note that one fundamental property of this transformation stems from the orthogonality of the basis functions. In signal processing the implementation of the Fourier transform is usually done with an algorithm known as the Fast Fourier Transform (FFT). In signal processing the usual implementation of the FFT requires the data to be segmented into discrete blocks whose length is a power of 2. Each block is processed sequentially. This process may lead to discontinuities at the boundaries of the block and is limited to a single resolution, in either time or frequency. Another limitation of this approach is that for each time increment, the same resolution in frequency domain is shown. There exist a number of orthogonal basis functions that may be used in a similar manner to transform data.

Other transforms may be used in like manner to practice the invention. Other multi-resolutional transforms may include, but are not limited to: Laplacian pyramids, Gaussian pyramids, gray level pyramids, and multi-resolutional Gabor filters.

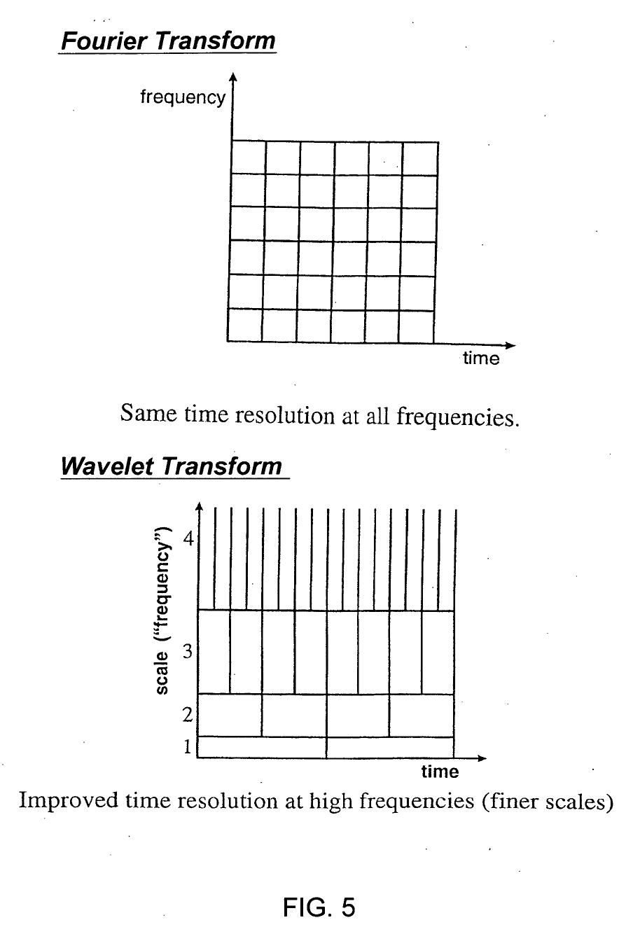

One family of basis functions, known as wavelets, exhibits a number of advantages over Fourier transforms. Wavelet functions are “compactly supported” meaning that they do not exist for infinite time duration. Wavelets are zero valued for most of time and oscillatory during a brief time duration. Using this type of basis function yields a transform that has some sense of time and frequency in the transformed data. Additionally, as illustrated in FIG. 5, wavelet transforms can provide for multi-resolutional or multi-scale analysis. Some wavelet transforms can be implemented in linear phase Finite Impulse Response (FIR) filter banks. FIR filters are discrete filters where the current calculated output value is dependent only on the data and the filter coefficients, not on previously calculated values through a feed-back loop. One feature of wavelet transforms is they can be implemented with less calculational complexity than Fourier transforms.

To use a wavelet basis function in a Discrete Wavelet Transform (DWT) requires the use of its impulse response as the coefficients in a perfect reconstruction filter bank. There are two groups of wavelet transforms that have found utility in signal processing. The first group is known as orthonormal, the second is biorthogonal. These groups of wavelet transforms are known in the art and will not be discussed in detail here. Orthornormal wavelets result in filters with an even number of coefficients, biorthogonal wavelets result in filters with an odd number of coefficients. In most signal processing applications the wavelet function itself is of little importance. The coefficients may be generated directly without regard for the analytical description of the wavelet function.

The calculation of the DWT and its inverse may be done with FIR filters. The analysis filters H₀ and H₁ perform the DWT; the synthesis filters F₀ and F₁ calculate the inverse transform. The filters H₀ and H₁ are selected in a way to allow filters F₀ and F₁ to reconstruct the input signal. The analysis high-pass filter H₁, the synthesis low-pass filter F₀, and the synthesis high-pass filter F₁ are generated from the synthesis low-pass H₀ in a way that ensures the output is equivalent to the input, times a time delay. To generate coefficients for the low-pass filter H₀ that will result in an orthomormal transform, the following constraints on the filter coefficients are applied:

$${\sum }_{i} {h}_{i}^{2} = 1$$

$${\sum }_{i} {h}_{i} {h}_{i + 2 k} = 0 , k \neq 0$$

$${\sum }_{i} {h}_{i} = \sqrt{2}$$

In the biorthogonal case the low-pass analysis filter and the low pass synthesis filter are of different length. Constraints are placed on both low-pass filters. These constraints are:

$${\sum }_{i} {h}_{i} {f}_{i} = 1$$

$${\sum }_{i} {h}_{i} {f}_{i + 2 k} = 0 , k \neq 0$$

$${\sum }_{i} {h}_{i} = \sqrt{2}$$

$${\sum }_{i} {( - 1 )}^{i} {h}_{i} = 0$$

$${\sum }_{i} {( - 1 )}^{i} {f}_{i} = 0$$

As can be shown, the orthornormal case is a subset of the more general biorthogonal case.

Application of these constraints will result in coefficients of a low-pass FIR filter. The corresponding filters can then be derived to ensure the filters provide for perfect reconstruction of the input signal at the output of the synthesis filter bank.

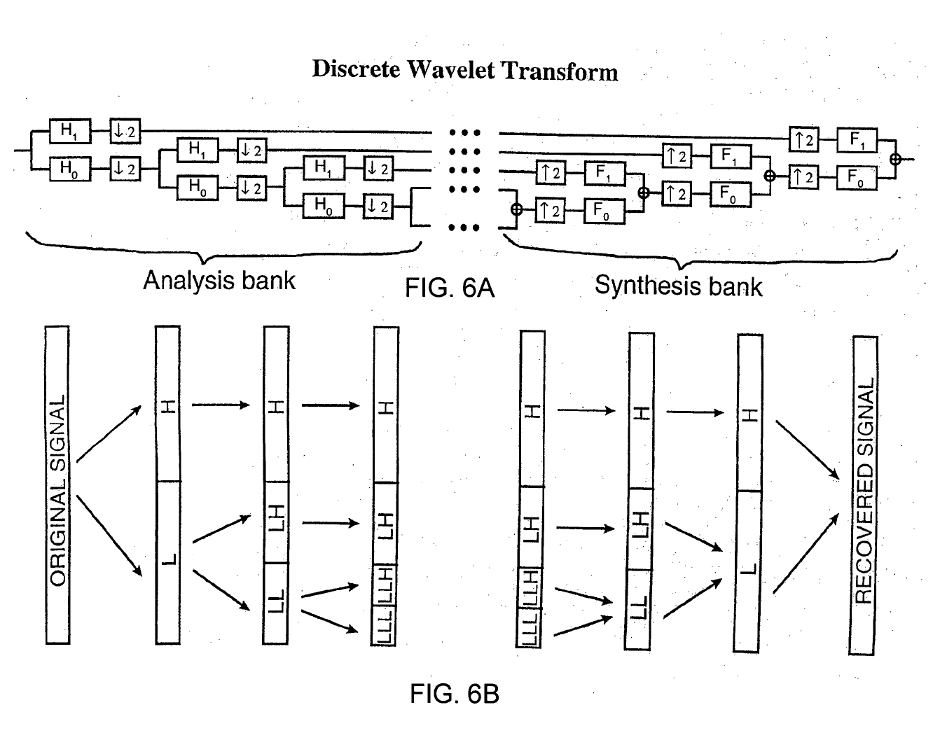

FIG. 6A illustrates the use of analysis and synthesis filter-banks to compute the DWT and its inverse. The first scale of resolution in the DWT is applied with low-pass filter H₀ and high-pass filter H₁. The resulting signal is then decimated by a factor of two, shown as ↓2. In practical application calculating every other output may combine the steps of filtering and decimation. The low frequency content is then filtered and decimated by low-pass filter H₀ and high-pass H₁ and the following decimators a second time to provide for a second scale or resolution of the low frequency content. This process may continue for any desired number DWT of scales or resolutions. The inverse transform begins with interpolation followed by filtering the signals with synthesis low-pass filter F₀ and synthesis high-pass filter F₁. The outputs are summed and sent to the next synthesis stage where the process is repeated.

FIG. 6B follows the discrete wavelet transform (DWT) of FIG. 6A, from the perspective of the actual information signal. At the first scale of resolution, the signal is split into low frequency content, L, and high frequency content H. After decimation by a factor of 2, the low frequency content L is split again into lower low frequency content LL, and higher low frequency content LH. After a second decimation by a factor of 2, the process is repeated again.

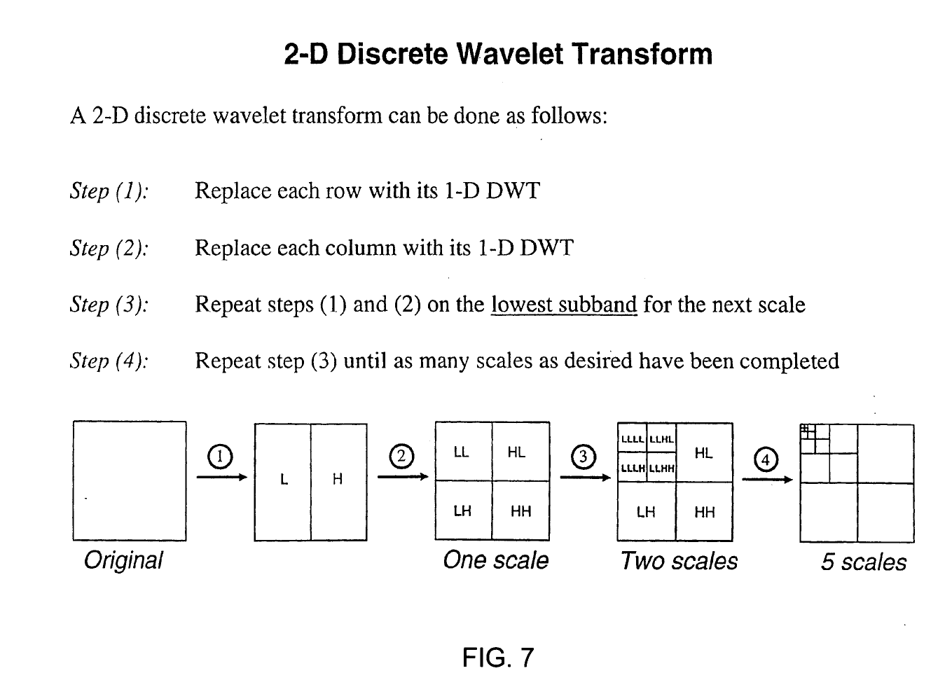

As shown in FIG. 7, when calculating a two dimensional transform, such as the DWT of an image, the transform of each row is calculated and the low frequency content is stored on a first half of an image, the high frequency content is stored on the other half. The calculation is then performed on the columns of the resultant image with the low frequency content being stored on a first half and the high frequency content stored on the other half. The result of the first scale of the transform is a image with 4 quadrants. One quadrant contains the low frequency content of both row and column processing, designated LL. Another quadrant contains the content which was high frequency with respect to column processing and low frequency with respect to row processing, designated LH. A third quadrant contains the content which was low frequency with respect to column processing and high frequency with respect to row processing, designated HL. The remaining quadrant contains the high frequency content of both row and column processing, designated HH. As illustrated in step 3, the content of the lowest sub-band LL is then processed with identical steps until the desired scale of resolution is achieved.

In like manner, three-dimensional DWTs may be calculated by applying the transform in a temporal manner across frames in video. A three dimensional DWT has an advantage of allowing for more processing, such as compression or coding, in the wavelet domain. Calculation of a three dimensional DWT is more complex than a two dimensional DWT and may therefore lead to more latency in processing. Additionally, in the case of multi-media data, the data to be transmitted may include information from more than one temporal plane. However, errors within any received frame may impact more than one temporal plane. In contrast, errors in reception of a two-dimensional transform system may be contained to a single temporal plane.

Once transformed, a number of processing steps may be applied to the data. In one embodiment of the present invention, an algorithm consistent with the JPEG 2000 specification is applied to compress the data. In some compression techniques entropy encoding is applied to the data once transformed. Entropy encoding is a process that applies different bit resolutions to different regions of the transformed image based on content. Other compression techniques are known in the art and may be used to practice the present invention. For example, many wavelet based compression techniques are based on an algorithm known in the art as the Zero-Tree Compression algorithm. One such algorithm is the Embedded Zero-tree Wavelet encoder (EZW). The EZW encoder is based on progressive encoding to compress an image into a bit stream with increasing accuracy. This means that when more bits are added to the stream, the decoded image will contain more detail, a property similar to JPEG encoded images. An analogy is the representation of the number π. The three-digit approximation, 3.14 is typically used and may be sufficient for some applications. Every digit we add increases the accuracy of the number, but we can stop at any accuracy we like. Progressive encoding is also known as embedded encoding, which explains the E in EZW. EZW encoding may result in a lossy compression that allows it to support a wide range of bit rates and resolutions.

Since the predominance of content in most images is low frequency, the lower sub-bands of a DWT contain the predominance of energy, and therefore the largest wavelet coefficients. It may be shown that the wavelet coefficient corresponding to any specific pixel of the lowest sub-band relates directly to four coefficients in the next higher sub-band. Additionally, each coefficient in that sub-band relates to four coefficients in the next higher sub-band. Therefore a coefficient in a low sub-band can be thought of as having four descendants in the next higher sub-band. This structure can be referred to as a quad-tree where every root node has four leaf nodes. In the EZW algorithm an initial threshold value is determined. A number of iterative passes through the transform are completed where the coefficient values are compared with the threshold. If the coefficient exceeds the threshold it is encoded as a positive (P), if it does not exceed the threshold it is encoded as a negative (N). A root node coefficient is encoded as a zero-tree (T). In the event that a root node coefficient does not exceed the threshold it is encoded as an isolated zero (Z). In subsequent passes throughout the transformed image the threshold is lowered and the process repeated for the coefficients. The encoding scheme may be lossy or lossless. In a lossless encoding scheme, the iterative process continues until the threshold is smaller than the smallest coefficient present in the transformed image. If a lossy transform is desired, the iterative process is stopped at a threshold level higher than the smallest wavelet coefficient. In this way, the compression rate can be controlled for lossless or lossy compression based on the application. Generally, lossy compression sacrifices (i.e., “loses”) some detail in order to maximize compression. Conversely, lossless compression reduces the size of the image with no lost information.

One feature of the present invention is that it allows multimedia content to be streamed through a communications channel at an increased distance. Traditional video compression techniques, like those employing standards from the Motion Picture Expert Group (MPEG), employ Discrete Cosine Transforms (DCTs) in a tiled manner. In other words, an image is transformed in smaller blocks, usually 8 by 8 pixels in size. The transformed block is compressed and may be stored on a media or transmitted through a communications media in compressed form. The process of decompression is very sensitive to bit error. In some MPEG compressions the residual Bit Error Rate (BER) required after error correction must approach 10⁻⁹. This type or restriction would only allow a single bit error in one billion bits. When bit errors exceed this threshold, corrupted blocks may appear in the decompressed image. Additionally, since most MPEG streams operate spatially, on each image frame, and temporally, frame to frame, corrupted blocks may cascade the error throughout a number of frames, making the error visible to an observer.

In contrast, multi-resolutional compression techniques, such as DWT based algorithms can tolerate a larger number of bit errors. Since bit errors occur randomly throughout the data, or image, a portion of the errors will occur within scales of less importance. These higher frequency scales provide fine detail in the image not the entire content of image itself. A residual bit error in a less important scale may result in a “softening” of edges in the image, rather than a loss of a block of the image. Additionally, referring back to FIG. 7, it is seen that as the transform progresses from one to five scales, the area of the image within the higher frequency scales predominates the transform. Since residual bit errors will occur randomly throughout the transformed data, the predominance of these errors will be in scales of lower importance. This additional resiliency to residual bit errors allows multi-resolutional compression techniques to effectively operate at a higher bit-error-rate (BER) than conventional DCT based algorithms such as MPEG. One implication of this resilience is that BER may be traded for increased distance of communications more effectively than in MPEG streams.

One feature of the present invention is that it enables the transmission of video even when higher BER are encountered. Those skilled in the art also realize that the transmission of video requires a substantial Quality-of-Service (QoS). Many different methods are employed to measure QoS, one of which is Bit-Error-Rate (BER). The methods of the present invention enable the transmission of video even in situations or environments that create higher bit-error-rates.

Currently standardized wavelet based video compression algorithms, like JPEG 2000, only calculate transforms and compress spatially. One advantage of spatial only algorithms is that errors are limited to a single image frame. Temporal DWT compression techniques are known in the art and may provide higher compression rates by taking advantage of similarities from frame to frame. One limitation of these techniques is that residual bit errors may cascade throughout a number of frames. In one embodiment of the present invention, a number of decompressed image frames may be buffered and if a residual error is found in these frames, data from a prior or later frame may be used to provide an estimate of the lost data.

Additionally, the low frequency content of an image DWT resembles the original image as a “thumb-nail” image. The loss or corruption of this portion of the image may make the entire image unrecoverable. In one embodiment of the present invention, this important “thumb-nail” image, may be processed and transmitted differently than the other portions of the image. For example, data representing the “thumb-nail” image may receive forward error correction (FEC) processing, and/or it may also be processed with adaptive, or fixed spreading codes. These processing steps (FEC and adaptive or fixed spreading) ensure that the important “thumb-nail” image is received at its intended destination. As discussed below, FEC encoding, as well as adaptive or fixed spreading adds additional data that must be transmitted. However, in one embodiment, by only processing the “thumb-nail” image with FEC and/or adaptive or fixed spreading, the total amount of additional data that is generated is minimized. In another embodiment that may be employed in a communication environment that includes factors making transmission difficult, the remaining portions of the image may also be processed with FEC and adaptive or fixed spreading. However, in some embodiments, the FEC rate, as discussed below, may be different for the “thumb-nail” portion of the image relative to the remaining portions of the image. This may also be true for the adaptive or fixed spreading processing that is performed on the image.

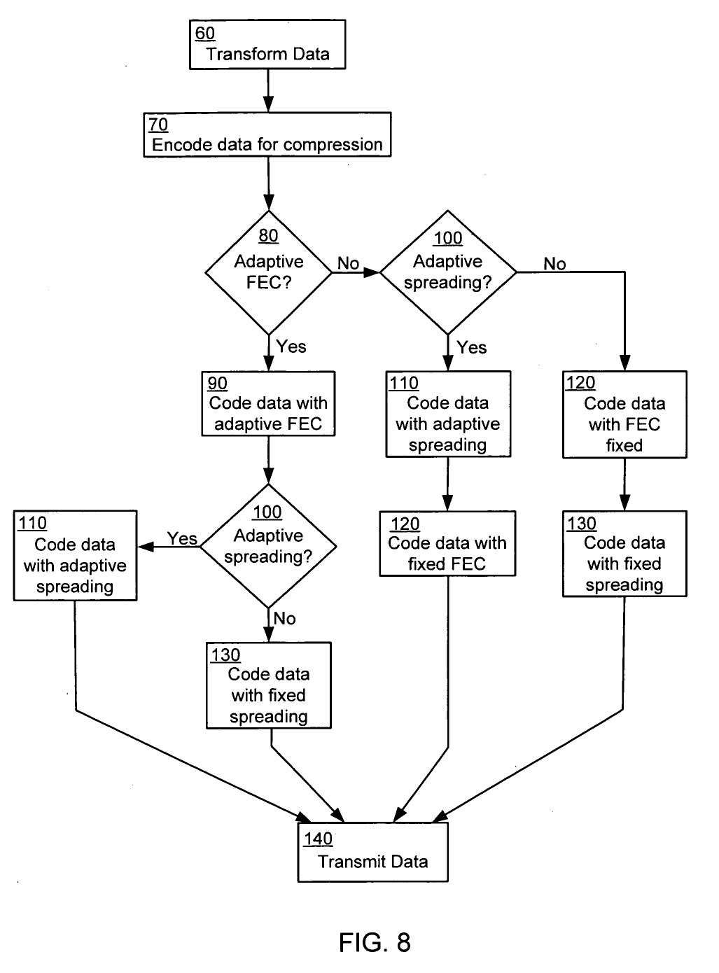

Referring now to FIG. 8, in one embodiment of the present invention, a video stream, image or other data is transformed in step 60. This transformation may be a two or three-dimensional transform including a wavelet transform, a discrete cosine transform, or any multi-resolutional transform discussed above. In step 70 the data is then coded for compression. A number of compression encoding methods are known in the art and may be used to practice the invention. By way of example and not limitation encoding step 70 may include progressive encoding, entropy encoding, zero-tree encoding, Lempel-Ziv encoding, Huffman coded format, an arithmetic coded format, and coding formats compliant with industry standards such as JPEG 2000. As is known in the art, entropy encoding is a coding scheme that involves the assignment of codes to symbols in a way that matches code lengths with the probability of occurrence.

In an embodiment that includes Forward Error Correction (FEC) step 80 determines if the FEC is to be adaptive. FEC is a method known in the art by which errors can be detected and corrected. In FEC algorithms an amount of redundancy, or other additional bits are added to the data to be sent in the encoding step. Upon reception a decoding step may be used to detect and correct any errors present in the received data. The number of additional or redundant bits added to the original data can be expressed in fractional form. For example, in ½ rate encoding the original data is doubled, in 1/4 rate encoding the resulting data set is 4 times as large as the original. Common encoding rates include ⅛ rate encoding, ¼ rate encoding, ⅜ rate encoding, ½ rate encoding, ⅝ rate encoding, ¾ rate encoding, and ⅞ rate encoding. Virtually any fractional rate encoding is possible and the invention is not limited with respect to the specific coding rate used. The ability for the decoder to correct errors is a function of the amount of additional bits in the data. Stated differently, a system employing a ¼ rate encoding will be able to detect and correct a larger number of errors than a system employing ½ rate

Referring back to the multi-resolutional example and specifically the DWT discussion illustrated by FIG. 7, it may be shown that the lowest frequency sub-band is essential to recovery of the data at a receiver. In an embodiment that includes adaptive FEC the sub-bands of the data may be encoded with different FEC rates. In this embodiment, the data corresponding to the smallest sub-band image may be encoded at a rate higher than other sub-bands. This increase in FEC encoding will improve the FEC decoder's ability to detect and correct errors in this region of the image. In a DWT the other sub-bands provide fine detail and if these sub-bands were corrupted the impact to image recovery would be minimized. The decision step 80 to apply adaptive FEC is therefore has implications on the reliability of the overall communications system.

Referring once again to FIG. 8, if the decision step 80 is affirmative, the adaptive FEC encoding is applied in step 90. If decision step 80 is negative, a decision must be made pertaining to adaptive spreading in step 100. Spreading a data signal with a spreading code improves reliability and allows a receiver to realize a spreading gain. Spreading is a known technique used in some spread spectrum technologies like Direct Sequence Spread Spectrum (DSSS) where a spreading code is multiplied by the each data bit. The resulting product, or spread data, will be larger than the original. While transmission and reception of this signal will require a higher data rate, an improvement is realized when detecting the signal at the receiver. Codes of different length provide different degrees of spreading gain. Longer codes provide more coding gain, but require a higher data rate to convey the data. By coding the lowest frequency sub-band with longer length codes than other sub-bands within the data, a higher degree of reliability is given to data that may be essential to the successful recovery of the information. Families of spreading codes, including but not limited to, block codes, hierarchal codes, Walsh codes, Golay codes, and ternary codes, are known in the art of communications and may be used to practice this aspect of the invention.

If decision step 100 is affirmative, adaptive spreading codes are applied in step 110. If decision step 100 is negative, the process may proceed to step 120, which applies a fixed FEC coding to the data. In step 130, the data is coded with fixed spreading. The data may then be sent to step 140 and transmitted across an ultra-wideband communications channel.

Alternatively, if decision step 80 is affirmative and adaptive FEC coding is applied in step 90, then in step 100, a decision is made as to adaptive spreading. In similar manner as discussed above if adaptive spreading is to be used, the data is adaptively spread in step 110. If adaptive spreading is not applied, the data is spread by fixed length codes in step 130. The data may then be transmitted across an ultra-wideband communications channel in step 140. It should be understood that adaptive and/or fixed spreading and FEC encoding are optional embodiments and do not limit the scope of the present invention. Multi-resolutional transforms provide for increased flexibility in processing but the techniques of adaptive FEC encoding and adaptive spreading described herein may be applied to other types of compression such as Discrete Cosine Transform based compression techniques like MPEG and JPEG.

Image and data compression may be characterized by data loss. Compression techniques that guarantee that a file, image, or multi-media streams are exactly reconstructed bit-by-bit are referred to as lossless. Compression that may remove redundant or less important bits from a file, image, or multi-media stream are commonly referred to as lossy. A number of lossless compression techniques are known, and many are based on entropy encoding techniques described above.

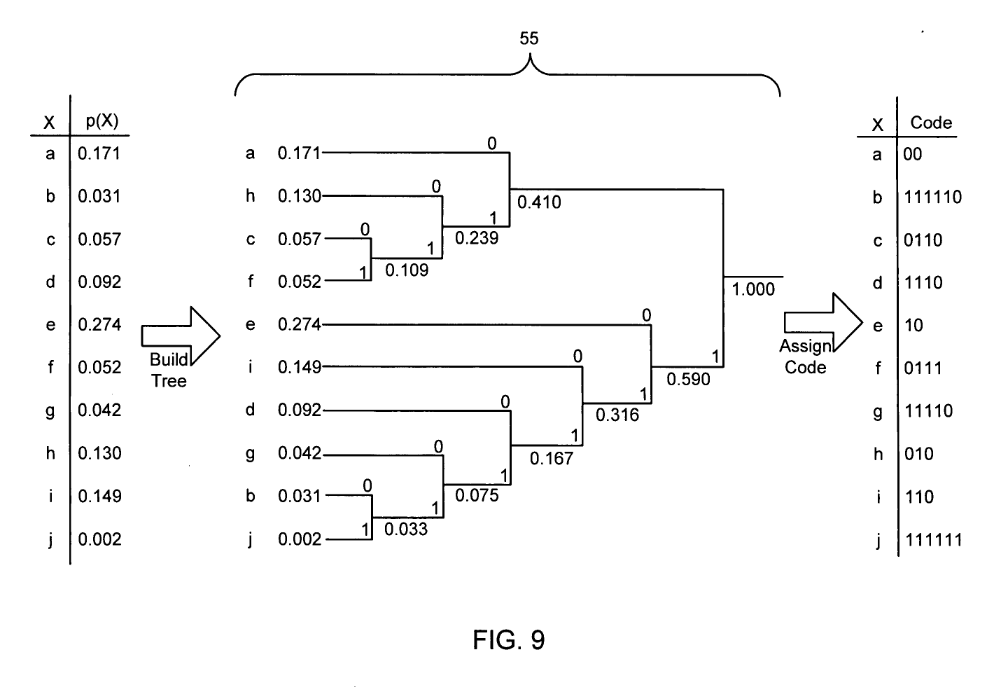

Referring to FIG. 9, one type of lossless compression technique is illustrated. The illustrated example, known as a Huffman algorithm, is provided as an example, and not as a limitation on the present invention. A Huffman encoder takes a block of input characters with fixed length and produces a block of output bits of variable length. It is a fixed-to-variable length code. The design of the Huffman code is optimal (for a fixed block-length) assuming that the source statistics are known a priori. The basic idea in Huffman coding is to assign short code words to those input blocks with high probabilities and long code words to those with low probabilities. A Huffman code is designed by merging together the two least probable characters in code tree 55, and repeating this process until there is only one character remaining. A code tree 55 is thus generated and the Huffman code is obtained from the labeling of the code tree 55. In this example the two least probable characters are “b” and “j”. These are combined to provide a combined probability of 0.033. The next two least probable are the character “g” and the combination of “b” and “j”. The combined probability of these is 0.075. Characters “c” and “f” are combined to provide a probability of 0.109. In like manner the remaining combinations are formed throughout the entire set until code tree 55 is complete with a 1.00 probability. Bit assignments are then given to the branches of code tree 55 as shown (“a” is bit 00, “e” is bit 10, etc.). Character encoding may then be generated from the tree. The resultant code is dependent on the probability of occurrence of each character, with shorter codes being assigned to higher probable characters. Huffman and Arithmetic coding are examples of entropy encoding since the code assignments are passed on probability of occurrence of a symbol. Other lossless compression algorithms are known in the art, including the Lempel-Ziv algorithm, and may be used to practice the current invention.

One feature of the present invention is that it provides for network communications using ultra-wideband transceivers and lossless compression techniques. The transceivers may be in communication with physical storage media where files may be stored using a lossless compression format. The very high data transmission rate of some types of ultra-wideband (potentially, Gigabits/second, wirelessly) enables the wireless transmission of losslessly compressed High Definition (HD) communication signals, such as HDTV, or HD movies, or other types of HD video or images. Un-compressed HD video data transmission rates are about 1.5 Gigabits/second. One type of lossless compression can reduce the data rate by ⅔, thus reducing an HD signal to 500 Megabits/second. Still, no conventional carrier-wave wireless communication technology exists that can transmit at a 500 Megabit/second data rate. One feature of the present invention is the use of ultra-wideband technology to wirelessly transmit losslessly compressed HD signals, a feat unachievable with conventional communication technologies.

Another feature of the present invention provides network communications using ultra-wideband transceivers and lossy compression that uses wavelet-based compression methods.

It will be appreciated by those skilled in the art that the data rate necessary to transmit video images varies with the resolution of the video image. For example, standard-definition television (SDTV) has a lower resolution than HDTV. For example, on type of SDTV can be broadcast in 704 pixels×480 lines or 640 pixels×480 lines. In contrast, one type of HDTV may have a vertical resolution of 1080 lines, usually with a horizontal resolution of 1920 pixels and an aspect ratio of 16:9. In addition, there are progressive-scan versions of the 1080-line resolution, but due to bandwidth limitations of conventional broadcast frequencies, it is only practical to use them at 24, 25, and 30 frames per second (1080p24, 1080p25, 1080p30). Progressively-scanned material at the higher frame rates of 50 and 60 hertz can only be sent over higher-bandwidth channels, and is not part of the broadcast standards. However, ultra-wideband communication technology can wirelessly transmit these HDTV signals. It will be appreciated that future HDTV standards may also be employed by the present invention.

The present invention may be employed in any type of network, be it wireless, wire, or a mix of wire media and wireless components. That is, a network may use both wire media, such as coaxial cable, and wireless devices, such as satellites, or cellular antennas. As defined herein, a network is a group of points or nodes connected by communication paths. The communication paths may use wires or they may be wireless. A network as defined herein can interconnect with other networks and contain sub-networks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology used by the network, such as, for example, a Transmission Control Protocol/Internet Protocol (TCP/IP) network, a Systems Network Architecture network, among others. A network as defined herein can also be characterized by whether it carries voice, data, or both kinds of signals. A network as defined herein may also be characterized by users of the network, such as, for example, users of a public switched telephone network (PSTN) or other type of public network, and private networks (such as within a single room or home), among others. A network as defined herein can also be characterized by the usual nature of its connections, for example, a dial-up network, a switched network, a dedicated network, and a non-switched network, among others. A network as defined herein can also be characterized by the types of physical links that it employs, for example, optical fiber, coaxial cable, a mix of both, unshielded twisted pair, and shielded twisted pair, among others.

Now, referring back to FIG. 4, which illustrates a network comprising two ultra-wideband transceivers 20. The transmitting ultra-wideband transceiver 20 (which can be either transceiver) communicates with storage media 10 retrieving data stored in a lossless compression format from storage media 10. This ultra-wideband transceiver 20 transmits this data across a communications medium 40, to the receiving ultra-wideband transceiver 20. The media as herein described may comprise an electrically conductive wire media 50, such as a power line or coaxial cable, or an optical communications medium such as a fiber optic cable. Alternatively, a wireless communication medium may be employed, and in this case, each of the ultra-wideband transceivers may include one or more antennas 35. The receiving ultra-wideband transceiver 20 receives the ultra-wideband signal from the communications media 40 and displays the data on a display device 30.

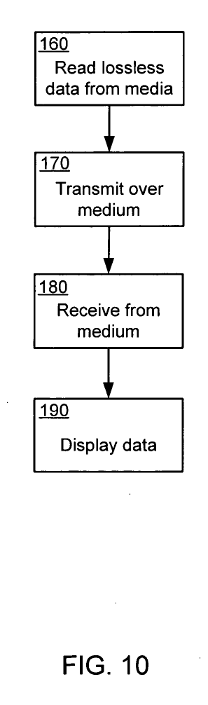

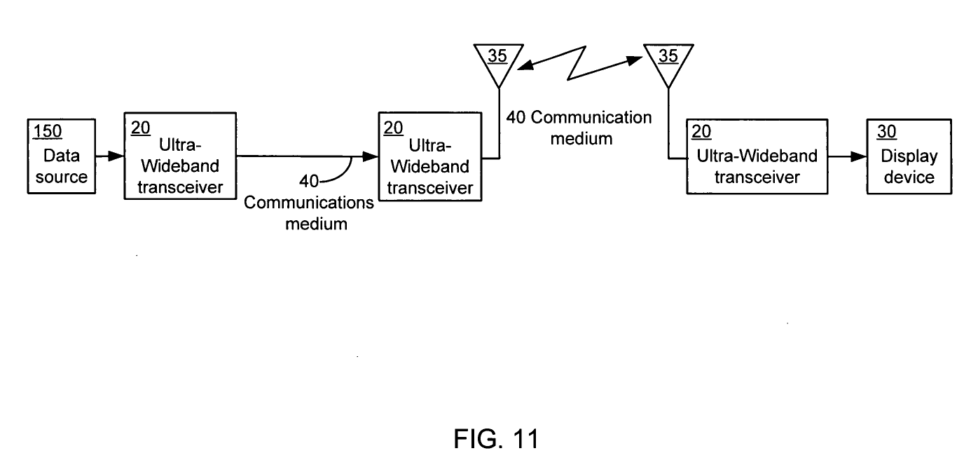

A method of communication consistent with one embodiment of the present invention is illustrated in FIG. 10. In step 160 lossless compressed data is read from a storage medium. The data is transmitted across a communications medium by an ultra-wideband transceiver in step 170. In step 180 a second ultra-wideband transceiver receives the data from the communications medium. The data is then displayed on a display device in step 190.

Another embodiment of the present invention, illustrated in FIG. 11, provides a communications network wherein data is received in a lossless compression format from a data source 150 at an ultra-wideband transceiver 20. This data source may be a storage medium or a communications media. A first ultra-wideband transceiver 20 transmits the data across a communications medium 40 to a second ultra-wideband transceiver 20. This ultra-wideband transceiver receives the data from the communications medium and retransmits it through a second communications medium to a third ultra-wideband transceiver 20. In this illustration, the first communication medium 40 may be a wire media, and the second communication medium 40 may be the air. In this embodiment, like the other embodiments described herein, the communication media may be an electrically conductive wire media, a wireless media or an optical fiber media.

The third ultra-wideband transceiver 20 displays the data on a display device 30. Display device 30 may be a stationary electronic device, such as a television, or personal computer, or it may be a portable electronic device, such as a mobile phone or personal digital assistant. In general terms display device 30 may be any device suitable for display of the data.

One feature of the present invention is that by using lossless compression formats, the information throughput is significantly increased over uncompressed formats for the same bit rate of communications. Another feature of the present invention is that by using wire media for communications media the range of an ultra-wideband network can be significantly extended over an exclusively wireless ultra-wideband (UWB) network. For example, some implementations of wireless UWB have been referred to as enabling Wireless Personal Area Networks (WPAN). The typical WPAN range is generally under 10 meters. A UWB signal on a wire media, such as a coaxial cable may be routed into a different part of a structure then be transmitted in that room as a wireless signal.

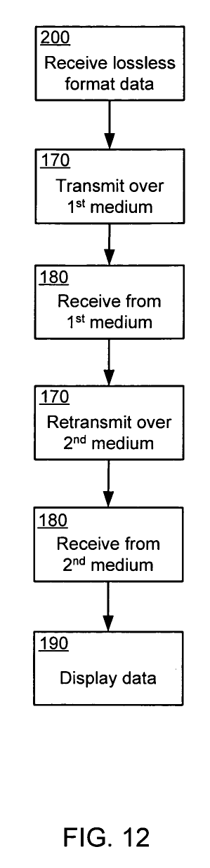

Another method consistent with one embodiment of the present invention is illustrated in FIG. 12. In step 200 data is received in a losslessly compressed format. The data is transmitted across a first communications medium as an ultra-wideband signal in step 170. The data is received in step 180 and retransmitted across a second communications medium as an ultra-wideband signal in step 170. The data is received from the second communications medium in step 180 and displayed in step 190.

Thus, it is seen that an ultra-wideband communications network and methods of communications are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A method of encoding data, the method comprising the steps of
calculating a data transform of the data;
encoding a first portion of the data transform with a forward error correction code at a first encoding rate; and
encoding a second portion of the data transform with a forward error correction code at a second encoding rate.

2. The method of claim 1, wherein the data transform is selected from a group consisting of: a discrete cosine transformation, a discrete wavelet transformation, a fast Fourier transformation, a Gabor transformation, a Laplician pyramid transformation, a Guassian pyramid transformation, and a multi-resolutional transformation.

3. The method of claim 1, wherein the first and second encoding rates are different.

4. The method of claim 1, wherein the first and second encoding rates are selected from a group consisting of: a ⅛ rate encoding, a ¼ rate encoding, a ⅜ rate encoding, a ½ rate encoding, a ⅝ rate encoding, a ¾ rate encoding, a ⅞ rate encoding and a 1 rate encoding.

5. The method of claim 1, further comprising the step of: spreading the encoded data with a spreading code, the spreading code selected from a group consisting of: block codes, hierarchal codes, Walsh codes, Golay codes, and ternary codes.

6. The method of claim 1, further comprising the step of: transmitting the transformed data by using an ultra-wideband signal transmitted through a communication medium.

7. The method of claim 6, wherein the ultra-wideband signal occupies a single radio frequency band or the ultra-wideband signal occupies multiple radio frequency bands.

8. The method of claim 6, wherein the ultra-wideband signal employs a technology selected from a group consisting of: an impulse technology, a direct sequence spread spectrum technology, a continuous wave technology, and an orthogonal frequency division multiplexing technology.

9. The method of claim 6, wherein the communication medium is selected from a group consisting of: an electrically conductive wire media, a wireless media, and an optical media.

10. The method of claim 6, further comprising the step of: receiving the transmitted data and displaying the data on a display device.

11. The method of claim 10, wherein the display device is selected from a group consisting of: a stationary electronic device, a portable electronic device, and a personal computer.

12. A method of communicating data, the method comprising the steps of
calculating a data transform of the data;
spreading a first portion of the data transform with a first spreading code having a first length; and
spreading a second portion of the data transform with a second spreading code having a second length.

13. The method of claim 12, wherein the data transform is selected from a group consisting of: a discrete cosine transformation, a discrete wavelet transformation, a fast Fourier transformation, a Gabor transformation, a Laplician pyramid transformation, a Guassian pyramid transformation, and a multi-resolutional transformation.

14. The method of claim 12, wherein the first and second spreading codes are selected from a group consisting of: block codes, hierarchal codes, Walsh codes, Golay codes, and ternary codes.

15. The method of claim 12, further comprising the step of: encoding the transformed data with a forward error correction code having an encoding rate, the encoding rate selected from a group consisting of: a ⅛ rate encoding, a ¼ rate encoding, a ⅜ rate encoding, a ½ rate encoding, a ⅝ rate encoding, a ¾ rate encoding, a ⅞ rate encoding and a 1 rate encoding.

16. The method of claim 12, further comprising the step of: transmitting the transformed data by using an ultra-wideband signal transmitted through a communication medium.

17. The method of claim 16, wherein the ultra-wideband signal occupies a single radio frequency band or the ultra-wideband signal occupies multiple radio frequency bands.

18. The method of claim 16, wherein the ultra-wideband signal employs a technology selected from a group consisting of: an impulse technology, a direct sequence spread spectrum technology, a continuous wave technology, and an orthogonal frequency division multiplexing technology.

19. The method of claim 16, wherein the communication medium is selected from a group consisting of: an electrically conductive wire medium, a wireless medium, and an optical medium.

20. The method of claim 16, further comprising the step of receiving the transmitted data and displaying the data on a display device.

21. The method of claim 20, wherein the display device is selected from a group consisting of: a stationary electronic device, a portable electronic device, and a personal computer.
